(19) United States
(12) Patent Application Publication
(10) Pub. No.: US 2014/0195959 A1
(43) Pub. Date: Jul. 10, 2014

(54) APPARATUS AND METHOD FOR PROVIDING A VIRTUAL KEYPAD

(71) Applicant: Samsung Electronics Co., Ltd., Gyeonggi-do (KR)

(72) Inventor: Hyunwoo YOO, Seoul (KR)

(73) Assignee: Samsung Electronics Co., Ltd., Gyeonggi-do (KR)

(21) Appl. No.: 14/149,405

(22) Filed: Jan. 7, 2014

(30) Foreign Application Priority Data
Jan. 7, 2013 (KR) 10-2013-0001413

(51) Int. Cl. G06F 3/0488; G06F 17/24

(52) U.S. Cl. CPC G06F 3/04886; G06F 17/24
USPC 715/773

(57) ABSTRACT

A method and apparatus are described for providing a virtual keypad. The method includes displaying a character string region and a virtual keypad region on a display, the character string region including a character string composed of a plurality of characters, and the virtual keypad region including an edit key; receiving a selection of the edit key; and displaying an edit key region including only the edit key and supporting a predefined selection function.

### PRIORITY

This application claims priority under 35 U.S.C. §119(a) to Korean Patent Application Serial No. 10-2013-0001413, which was filed in the Korean Intellectual Property Office on Jan. 7, 2013, the entire disclosure of which is hereby incorporated by reference.

### BACKGROUND

1. Field of the Invention

The present disclosure relates generally to virtual keypad operation, and more particularly, to an apparatus and method for providing a virtual keypad.

2. Description of the Related Art

Mobile devices including touch screens often offer a virtual keypad having graphical input keys in order to maximize the size of the displays and minimize the size and number of mechanical keys required.

However, a conventional virtual keypad is designed for simply entering a touched character in an input window, which often causes difficulty in selectively editing or deleting characters. For example, when an error is found in entered characters, the user often needs to press a backspace key several times in order to delete the error. This also removes of some of the characters other than the error, and a user should re-enter the removed characters.

### SUMMARY

Accordingly, the present invention is designed to address at least the problems and/or disadvantages described above and to provide at least the advantages described below.

An aspect of the present invention is to provide a method and apparatus for providing a virtual keypad for easily and intuitively editing text.

In accordance with an aspect of the present invention, a method of providing a virtual keypad is provided. The method includes displaying a character string region and a virtual keypad region on a display, the character string region including a character string composed of a plurality of characters, and the virtual keypad region including an edit key; receiving a selection of the edit key; and displaying an edit key region including only the edit key and supporting a predefined selection function.

In accordance with an aspect of the present invention, an apparatus is provided for providing a virtual keypad. The apparatus includes a display unit configured to display a character string region and a virtual keypad region, the character string region including a character string composed of a plurality of characters, and the virtual keypad region including an edit key; and a control unit configured to control the display unit to display an edit key region thereon, when the edit key is selected. The edit key region includes only the edit key and supports a predefined selection function.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates an apparatus for providing a virtual keypad in accordance with an embodiment of the present invention;

FIG. 2 illustrates a control unit in accordance with an embodiment of the present invention;

FIG. 3 is a flow chart illustrating a method of providing a virtual keypad in accordance with an embodiment of the present invention;

FIG. 4 illustrates examples of screenshots displayed while providing a virtual keypad in accordance with an embodiment of the present invention;

FIG. 5 illustrates examples of screenshots displayed while providing a virtual keypad in accordance with an embodiment of the present invention;

FIG. 6 illustrates an example of a screenshot displayed while providing a virtual keypad in accordance with an embodiment of the present invention;

FIG. 7 illustrates an example of a screenshot displayed while providing a user function based on an operation of a virtual keypad in accordance with an embodiment of the present invention;

FIG. 8 illustrates an example of a screenshot displayed while providing a user function based on an operation of a virtual keypad in accordance with an embodiment of the present invention; and

FIG. 9 illustrates an example of a screenshot displayed while changing an edit key in a virtual keypad in accordance with an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

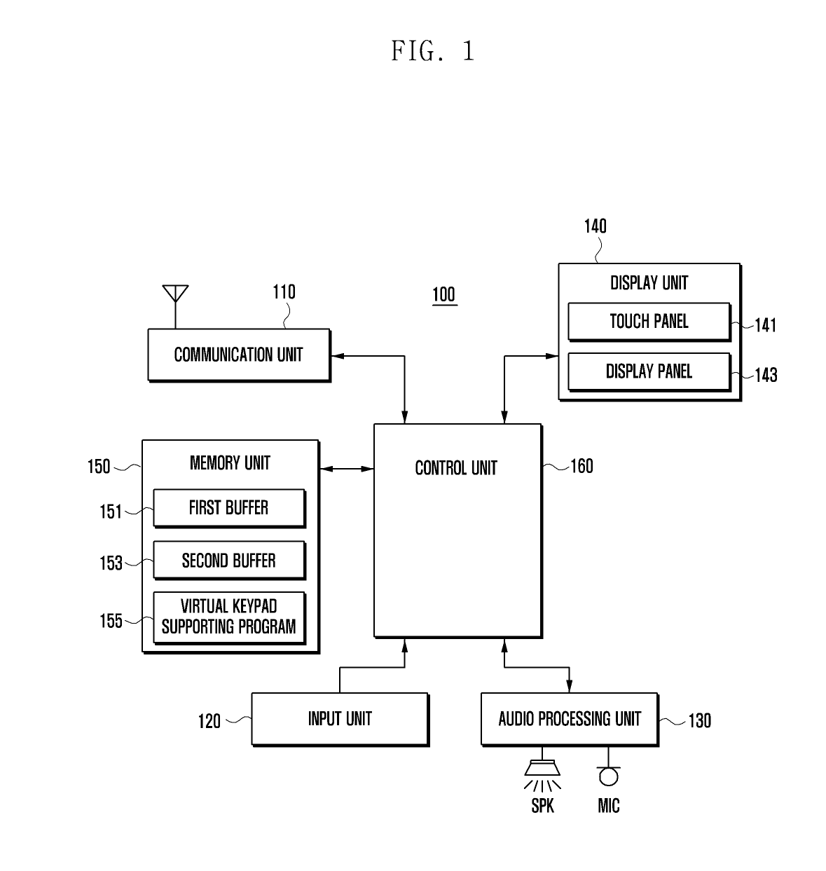

FIG. 1 illustrates an apparatus for providing a virtual keypad in accordance with an embodiment of the present invention.

Referring to FIG. 1, the apparatus 100, e.g., an electronic device, such as a mobile terminal, includes a communication unit 110, an input unit 120, an audio processing unit 130, a display unit 140, a memory unit 150, and a control unit 160.

The apparatus 100 provides a virtual keypad, also referred to as a software input panel, e.g., in response to the activation of a specific user function or a user input. In accordance with an embodiment of the present invention, the virtual keypad includes an edit key for activating a more intuitive text edit function. For example, when an input event for displaying an edit key occurs, the apparatus 100 displays an edit key region for moving an edit key and selecting a portion of a character string entered in an input region, in response to the movement of the edit key.

The edit key region may be separately from the input region. Thereafter, based on a subsequent input event, a desired edit function is performed for the selected portion of a character string. A more detailed description will be provided below.

The communication unit 110 supports a communication function of the apparatus 100. However, when the apparatus 100 does not support a communication function, the communication unit 110 may be omitted. The communication unit 110 may include at least one communication module supporting different communication technologies, e.g., 2G, 3G, 4G, etc.

The control unit 160 activates the communication unit 110 and controls the communication unit 110 to establish a communication channel associated with a requested service. In this process, an input of information for a communication function of the communication unit 110 may be entered, and therefore, the apparatus 100 may output a virtual keypad designed for such an input. For example, the apparatus 100 may output a suitable virtual keypad, depending on a currently running function executed by the communication unit 110.

For example, when an input for performing a voice call is received, the apparatus 100 may output a virtual keypad including a conventional numerical telephone array. Further, when an input event for entering text is received, the apparatus 100 may output a virtual keypad including a QWERTY array. In accordance with an embodiment of the invention, each of these virtual keypads also includes an edit key initiating an intuitive and simple editing function for an input string.

The input unit 120 creates various input signals for the operation of the apparatus 100. More specifically, the input unit 120 selectively includes various mechanical keys, such as a button key, a side key, a home key, etc., and also may be realized as a virtual keypad via a touch panel 141.

A virtual keypad is displayed on the display unit 140, having a number of keys to create input signals in response to a user's touch gesture. For example, the input unit 120 creates an input signal for calling a virtual keypad from the memory unit 150 and an input signal for removing a virtual keypad from the display unit 140. Such input signals may be delivered to the control unit 160 and converted into corresponding commands to control a virtual keypad. When the display unit 140 supports a touch-based input function, the display unit 140 may act as the input unit 120. Therefore, the above-discussed input signals may also be created through the display unit 140, i.e., via the touch panel 141.

The audio processing unit 130 is processes audio signals created during the operation of the apparatus 100. The audio processing unit 130 includes a speaker (SPK), and a microphone (MIC).

Additionally, the audio processing unit 130 may support various feedback sounds and sound effects in connection with touch events in the operation of a virtual keypad. For example, when a touch event is received to select and operate an edit key of a virtual keypad, the audio processing unit 130 outputs a specific feedback sound or sound effect to identify the selection of the edit key.

Further, when a touch event for applying a predefined function is created after a specific region is selected using an edit key, the audio processing unit 130 may output a specific feedback sound or sound effect associated with such a function.

A vibration may be applied in addition to or instead of the above-mentioned feedback sound or sound effect.

The display unit 140 displays various screens for the operation of the apparatus 100. For example, the display unit 140 displays an idle screen, a menu screen, a lock screen, a specific screen on which a plurality of icons and/or widgets are arranged, a webpage screen, a message writing screen, a memo or note writing screen, etc.

Particularly, the display unit 140 outputs a virtual keypad in response to a predefined schedule or user request, and supports the creation of an input signal through a virtual keypad. Accordingly, the display unit 140 includes the touch panel 141 and a display panel 143.

The touch panel 141 may be disposed on or under the display panel 143 and offers location information associated with a user touch input. The touch panel 141 may further define a touch valid region and a touch invalid region, depending on the properties of screens outputted on the display panel 143. For example, in order to select and operate an edit key and apply a related function, the touch panel 141 may modify the definition of such touch regions within a virtual keypad under the control of the control unit 160. The touch panel 141 may offer, to the control unit 160, information about locations and touch types in connection with various touch events created in a touch valid region. Touch types include a tap, a drag, a flick, a long press, a touch release, a multi touch, etc.

The display panel 143 outputs various images associated with the operation of user functions. Particularly, the display panel 143 outputs a virtual keypad image, which is selected from a 3*4 key array type, a 4*3 key array type, a 4*5 key array type, a 5*4 key array type, a QWERTY key array type, a Dvorak key array type, etc. Such a key array type may have numerical arrangement, alphanumeric arrangement, or different languages, e.g., Korean, Japanese, Chinese, Spanish, Arabic, etc. However, in accordance with an embodiment of the present invention, the virtual keypad includes a specially allocated edit key, regardless of the key array type.

The memory unit 150 stores various data and programs for the operation of the apparatus 100. For example, the memory unit 150 stores an Operating System (OS) for the operation of the apparatus 100, data received or entered during the operation of the apparatus 100, etc. Particularly, the memory unit 150 stores a virtual keypad supporting program 155 for operating an edit key and the first and second buffers 151 and 153 used for applying a function of the edit key.

The virtual keypad supporting program 155 supports the output of a virtual keypad on the display unit 140 in connection with a text input function to enter numbers, characters or special characters. The virtual keypad supporting program 155 also includes an output supporting routine for supporting the output of a predefined virtual keypad in response to a request for a specific user function such as a call function, a memo function, a message function, a web access function, and a document edit function or in response to an input event for calling a virtual keypad or in response to schedule information. The output supporting routine may support the output of a specific virtual keypad selected from various types of virtual keypads depending on the type of a currently activated user function. Additionally, the output supporting routine may support the output of any other type virtual keypad in response to a change of user setting. In accordance with an embodiment of the present invention, the output supporting routine includes an edit key operating routine for operating an edit key.

For example, the edit key operating routine includes a routine for defining a portion of a virtual keypad region as an edit key region used for the operation of an edit key, when an edit key is selected in a virtual keypad, and a routine for receiving a touch event for the operation of the edit key, e.g., a drag event, from the edit key region.

Additionally, the edit key operating routine may further include a routine for preliminarily applying a selection function to a certain portion of a character string entered in an input region in response to a drag event, and a routine for finally applying the selection function in response to a touch release event.

Further, the edit key operating routine may include a routine for supporting a buffer control in connection with the above process of preliminarily or finally applying the selection function.

The first buffer 151 stores an entire character string entered in an input region, when a touch event for the operation of an edit key happens. Such a character string stored in the first buffer 151 may be compared with at least one character stored in the second buffer 153 in a process of applying a selection function. Further, the first buffer 151 may be initialized when a selection function is completely applied. The size of the first buffer 151 may be dynamically determined according to the size of a character string entered in an input region, and then returned when the operation of an edit key is completed.

The second buffer 153 stores at least one character selected by an edit key. Such characters stored in the second buffer 153 may be used for preliminarily or finally applying a selection function. The second buffer 153 may be allocated with the same size as that of the first buffer 151 or dynamically allocated in real-time during the operation of an edit key. When the operation of an edit key is completed, the second buffer 153 may be returned.

Alternatively, each of the first and second buffers 151 and 153 may be fixedly allocated for the edit of characters, may be initialized in response to the activation of an edit key, and store a character string or characters during the operation of the edit key.

The control unit 160 controls the overall operation of the apparatus 1000, e.g., signal flows, data processing, text editing, etc.

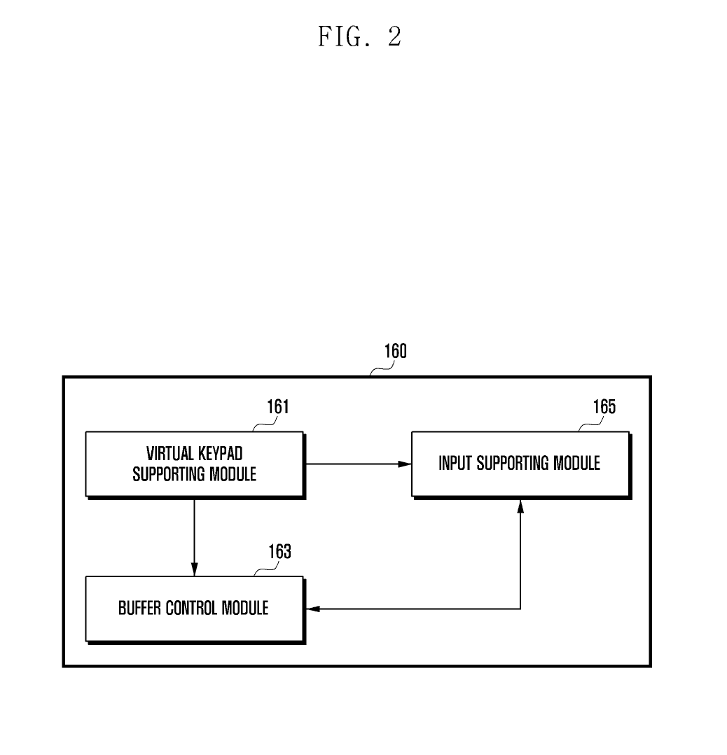

FIG. 2 illustrates a control unit in accordance with an embodiment of the present invention. Specifically, FIG. 2 illustrates the control unit 160 including elements for providing an edit key.

Referring to FIG. 2, the control unit 160 includes a virtual keypad supporting module 161, an input supporting module 165, and a buffer control module 163.

The virtual keypad supporting module 161 supports the output of a virtual keypad. For example, when an event for calling a virtual keypad is received while a specific user function is activated, the virtual keypad supporting module 161 outputs a predefined type of virtual keypad corresponding to the activated user function, to the display unit 140. The types of virtual keypads may be defined differently according to user functions and changed in response to a change of user setting. Accordingly, the virtual keypad supporting module 161 may offer a menu for changing a virtual keypad setting.

When a touch event associated with a virtual keypad is received while the virtual keypad is displayed on the display unit 140, the virtual keypad supporting module 161 may offer the touch event to the input supporting module 165. Particularly, when a touch event for selecting an edit key from a virtual keypad is received, the virtual keypad supporting module 161 outputs the touch event to the buffer control module 163 and the input supporting module 165.

The virtual keypad supporting module 161 may also define a touch region used for the operation of an edit key. For example, in order to notify a user that such a touch region is offered for the operation of an edit key, the virtual keypad supporting module 161 may output a certain image in a virtual keypad region.

Alternatively, the virtual keypad supporting module 161 may provide an edit key region and a virtual keypad region at different layers.

Further, the virtual keypad supporting module 161 may remove a virtual keypad region from the display unit 140 and instead output an edit key region including only an edit key.

The virtual keypad supporting module 161 receives a touch event, e.g., a drag event, from a touch region used for the operation of an edit key and provides the touch event to the buffer control module 163 and the input supporting module 165.

The input supporting module 165 checks information mapped to a virtual key selected according to a touch event received from the virtual keypad supporting module 161 and then enters characters in response to such information. Particularly, when a touch event associated with an edit key is received, the input supporting module 165 performs a selection function with regard to one or more characters from the entered character string, in response to the received touch event. For example, depending on a movement of an edit key, the input supporting module 165 highlights selected characters, deletes, copies, or cuts the selected characters, or restores a desired part of the deleted or cut characters. Also, the input supporting module 165 may support a return to a state of displaying a virtual keypad after the above selection function is completed.

The buffer control module 163 controls the operation of the first buffer 151 when a touch event for selecting an edit key is received from the virtual keypad supporting module 161, and controls the operation of the second buffer 153 when a touch event for operating an edit key is received from the virtual keypad supporting module 161. Specifically, the buffer control module 163 controls the first buffer 151 to store the entire character string entered in an input region when a touch event for selecting an edit key happens. Thereafter, the buffer control module 163 controls the second buffer 153 to store one or more characters selected from the character string stored in the first buffer 151 according to a movement of an edit key. The buffer control module 163 may offer both the character string stored in the first buffer 151 and characters stored in the second buffer 153 to the input supporting module 165 in response to a request from the input supporting module 165.

Additionally, when a selection function is applied according to the control of the input supporting module 165, the buffer control module 163 may initialize the first buffer 151 and the second buffer 153.

When the first and second buffers 151 and 153 are designed to be dynamically allocated, instead of being fixed, the buffer control module 163 may control a dynamic allocation and return of the first and second buffers 151 and 153. For example, the buffer control module 163 may allocate and return the first buffer 151 to have a size suitable for storing the entire character string entered in an input region, and also allocate and return the second buffer 153 to have a size suitable for storing one or more characters selected according to the operation of an edit key.

As described above, the apparatus 100 supporting the operation of a virtual keypad in accordance with an embodiment of the present disclosure provides the virtual keypad with an edit key, but also allows a user to intuitively and simply apply a desired selection function to one or more selected characters through the operation of the edit key. Particularly, the apparatus 100 allows a user to easily and clearly select desired characters by offering an edit key in some region other than an input region for entering a character string, and also provides a user with the selection function in response to the completion of a touch event. Therefore, the apparatus 100 alleviates a difficulty normally found in selecting desired characters for editing because some characters to be selected are hidden by a touch tool in case the touch tool directly touches an input region for entering a character string. Additionally, the device 100 allows a user to easily select a plurality of characters at one time through a movement of an edit key.

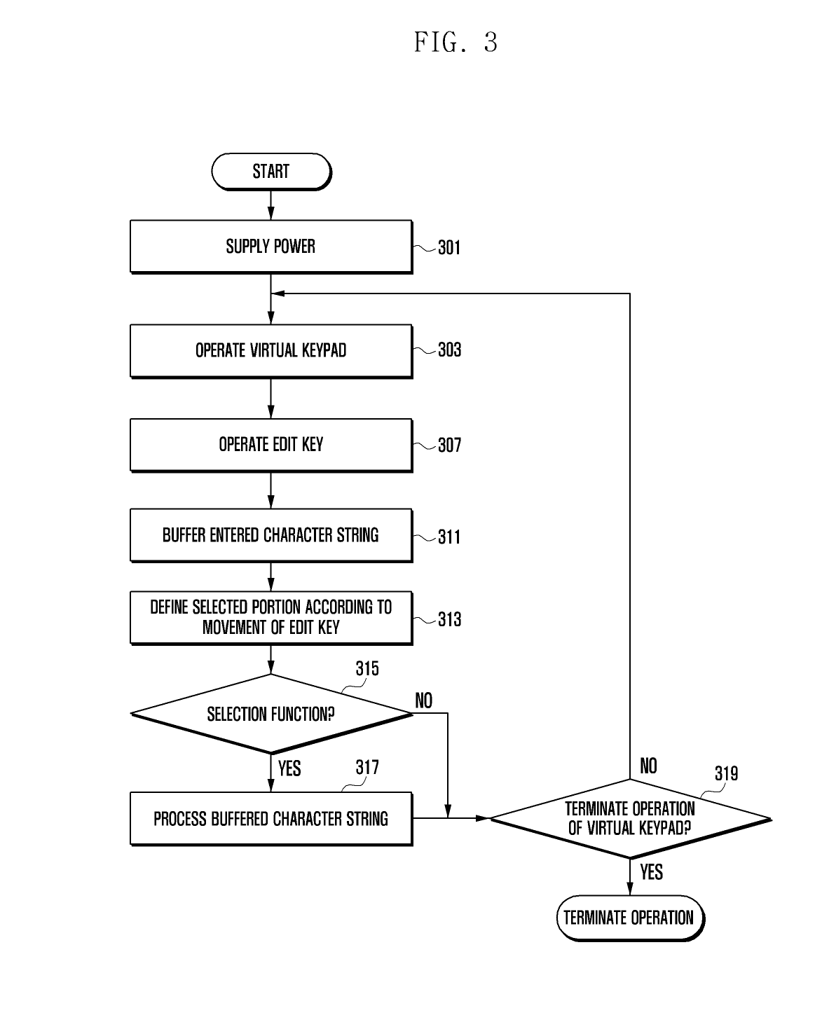

FIG. 3 is a flow chart illustrating a method of providing a virtual keypad in accordance with an embodiment of the present invention.

Referring to FIG. 3, the apparatus 100 supplies power to respective elements for the operation of the apparatus 100 in step 301. Particularly, the control unit 160 supplies power for a specific user function.

In step 303, an input event is received for operating a virtual keypad.

In step 307, the apparatus 100 receives a touch event for operating an edit key. That is, a user selects the edit key displayed on the virtual keypad.

In step 311, the control unit 160 of the apparatus 100 controls the first buffer 151 to buffer an entered character string.

In step 313, the control unit 160 identifies a selected portion of the entered character string according to a movement of the edit key. More specifically, the control unit 160 selects characters within the selected portion and controls the second buffer 153 to buffer the selected characters. For example, to select characters, the control unit 160 may perform a calculation for selecting a portion of a character string according to a movement of an edit key.

For example, the control unit 160 may select a character of 1 byte or 2 byte according to a predefined unit in a movement of an edit key. This size of character selection may be defined differently depending on types of language. Further, the control unit 160 may preliminarily apply a function to the selected portion.

For example, the control unit 160 may remove characters in the selected portion from the display unit 140 in response to a movement of an edit key.

Further, the control unit 160 may restore the removed characters in response to a reverse movement of an edit key. For example, the control unit 160 may control the second buffer 153 to buffer characters selected according to a movement of an edit key and, based on the buffered characters, perform a restoring process.

In step 315, the control unit 160 determines whether a touch event for performing a predefined selection function happens. If the touch event occurs, the control unit 160 processes an input queue in step 317, i.e., processes a buffered character string. For example, the control unit 160 may subtract characters buffered in the second buffer 153 from the entire character string stored in the first buffer 151 and then output the remaining characters only to an input region.

In step 319, the control unit 160 determines whether an input event for terminating the operation of a virtual keypad is received. If so, the control unit 160 removes the virtual keypad from the display unit 140. However, if there is no input event for terminating the operation of a virtual keypad, the process returns to step 303.

Although the description of FIG. 3 above is focused on a deletion function using an edit key, this is exemplary, and the present invention is not limited thereto. For example, a copy and paste function or a cut and paste function may also be used through an edit key.

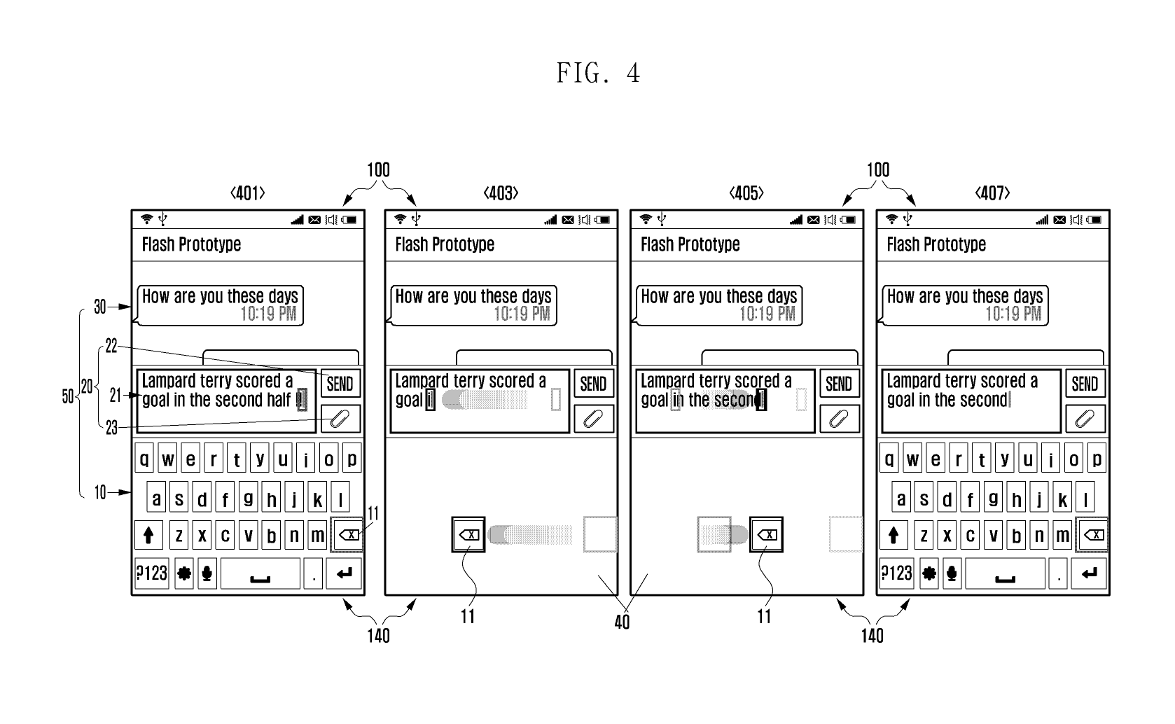

FIG. 4 illustrates examples of screenshots displayed while providing a virtual keypad in accordance with an embodiment of the present invention.

Referring to FIG. 4, a message function is activated, the apparatus 100 outputs a message function screen 50 on the display unit 140, as illustrated in a screenshot 401. The message function screen 50 includes a virtual keypad region 10, an input region 20, and an output region 30.

The virtual keypad region 10 includes an array of various keys. For example, screenshot 401 illustrates a QWERTY array of letters. Notably, the virtual keypad region 10 includes a delete key 11, as an edit key.

The input region 20 displays characters corresponding to keys selected in the virtual keypad region 10. The input region 20 includes a character string region 21 for displaying an entered character sting, a send key 22 for requesting transmission of a character string displayed in the character string region 21, and an annex key 23 for adding an appended file. A character string displayed in the character string region 21 is based on a user input, so that the length and lines of a character string may vary. For example, screenshot 401 illustrates two lines of a character string in the input region 20.

The output region 30 displays a character string transmitted to another device by a selection of the send key 22, or displays a message received from another device.

When the delete key 11 is selected by a suitable touch event (e.g., a long press), the control unit 160 changes the virtual keypad region 10 to a delete key region 40 for the operation of the delete key 11, as illustrated in screenshot 403. For example, the control unit 160 controls the display unit 140 to display, as the delete key region 40, a screen image including only the delete key 11, instead of the virtual keypad region 10.

Additionally, the control unit 160 controls the first buffer 151 to buffer the character string displayed in the character string region 21.

If a tap event happens on the delete key 11, the control unit 160 may individually delete characters located behind a cursor 25 in the input region 20, depending on the number of tap events. Further, instead of a long press, another suitable touch event may be alternatively used for the operation of the delete key 11 based on the delete key region 40.

When the delete key 11 is being touched, a user may create a drag event by moving the delete key 11 as illustrated in a screenshot 403. Thereafter, the control unit 160 selects a portion of a character string in the character string region 21 corresponding to the drag event, and also deletes the selected portion from the display unit 140. Particularly, the control unit 160 selects and deletes characters in proportion to a drag distance in the first direction (e.g., to the left) from the position of the cursor 25 disposed in the character string region 21. The control unit 160 controls the second buffer 153 to buffer characters selectively deleted from the position of the cursor 25.

If a drag event happens in a second direction (e.g., to the right), the control unit 160 may restore characters deleted from the display unit 140, according to such a drag event in the second direction as illustrated in screenshot 405.

Thereafter, when a touch release event for releasing a touch event from the delete key 11 occurs, the control unit 160 applies a final edit of the partially deleted characters to the character string region 21, as illustrated in screenshot 407. Namely, the control unit 160 controls the display unit 140 to display remaining characters including restored characters. The control unit 160 may remove the delete key region 40 and instead output the virtual keypad region 10.

In screenshots 401 to 407, the position of the cursor 25 may vary depending on a user request. Namely, instead of being located at the end of a character string as illustrated therein, the cursor 25 may be located at any position according to a touch on the character string region 21. If the cursor 25 is located at a middle position of a character string, the control unit 160 may delete characters from the display unit 140 in response to a movement of the delete key 11 in the first or second direction from a current position of the cursor 25. If a movement direction of the delete key 11 is changed, the control unit 160 may restore the deleted characters.

Additionally, if a movement distance in the second direction (or in the first direction) is greater than that in the first direction (or in the second direction), the control unit 160 may initialize the direction from the cursor 25. That is, if the cursor 25 moves by one character in the first direction and then moves by two characters in the second direction, the control unit 160 may regard a movement as occurring by one character in the second direction. Then the control unit 160 may delete one character in the second direction.

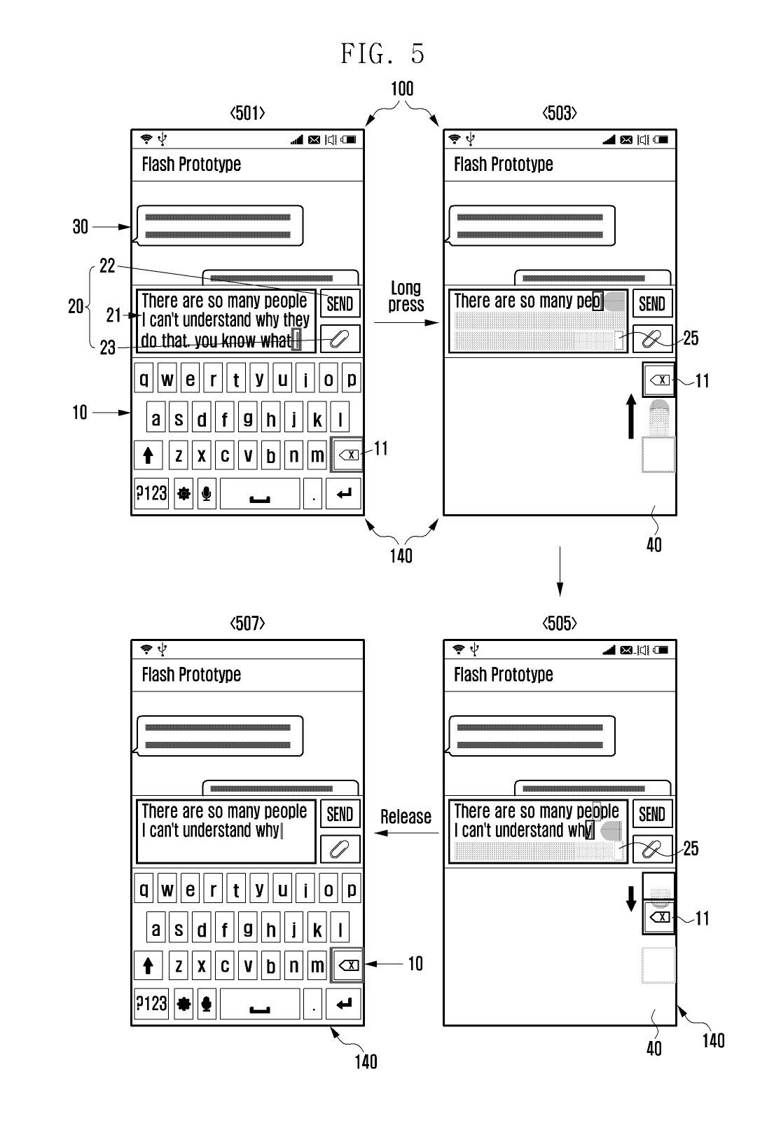

FIG. 5 illustrates examples of screenshots displayed while providing a virtual keypad in accordance with an embodiment of the present invention.

Referring to FIG. 5, when an input event for activating a message function occurs, the apparatus 100 outputs a relevant screen on the display unit 140, as illustrated in screenshot 501. As described above, the screen includes the virtual keypad region 10, the input region 20, and the output region 30. Also, the virtual keypad region 10 includes the delete key 11 as an edit key, and the input region 20 includes the character string region 21, the send key 22, and the annex key 23.

When the delete key 11 is selected by a suitable touch event, the control unit 160 outputs the delete key region 40 for the operation of the delete key 11, as illustrated in screenshot 503. Using the delete key 11 displayed in the delete key region 40, a user may select a portion of characters from a character string displayed in the character string region 21. For example, as previously described in relation to FIG. 4, the user may select characters by moving the delete key 11 in a particular direction.

As illustrated in screenshot 503, the delete key 11 may be moved in the upward direction such that the control unit 160 deletes all characters located in a line above the cursor 25 in the character string region 21.

As described above, when a touch event happens for selecting the delete key 11, the control unit 160 controls the first buffer 151 to buffer all characters included in the character string region 21. Thereafter, in response to an upward movement of the delete key 11, the control unit 160 controls the second buffer 153 to buffer deleted characters disposed in a same line. Additionally, if a leftward movement follows an upward movement, the control unit 160 may further delete characters in response to such a leftward movement of the delete key 11. However, if a rightward movement follows an upward movement, the control unit 160 may restore some deleted characters in response to such a rightward movement of the delete key 11.

As illustrated in screenshot 505, if a downward movement of the delete key 11 happens, the control unit 160 may restore all characters of one line. Thereafter, when a touch release event happens as shown in a screenshot 507, the control unit 160 removes the deleted characters from the display unit 140 and outputs the virtual keypad region 10. At this time, the control unit 160 may re-initialize the first and second buffers 151 and 153.

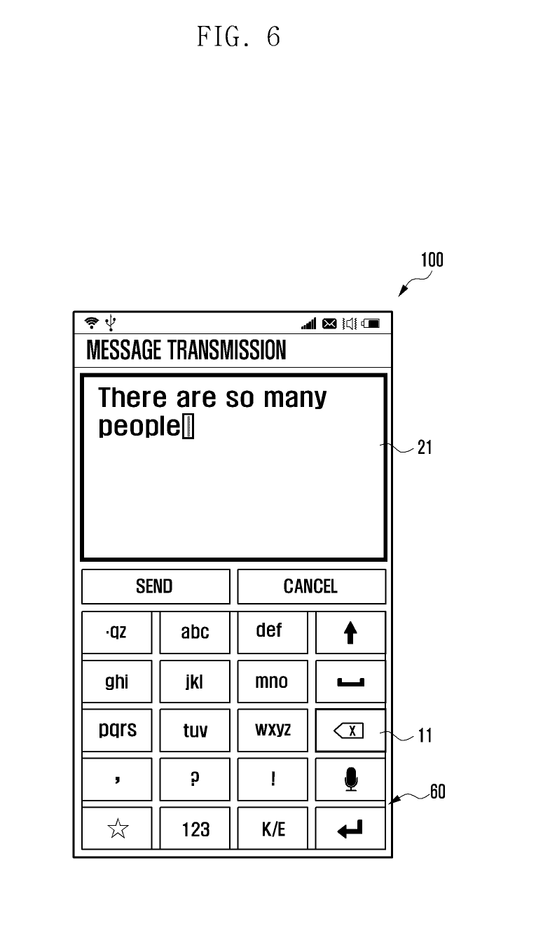

FIG. 6 illustrates an example of a screenshot displayed while providing a virtual keypad in accordance with an embodiment of the present invention.

Referring to FIG. 6, the display unit 140 displays a virtual keypad 60 including a 4*5 key array type, which may be used for an input of special language or a calculator.

As discussed above, other key array types, such as a 3*4 key array type, may be alternatively used for the virtual keypad 60. In any case, the virtual keypad 60 includes the above-described edit key, e.g., delete key 11 for a deletion function, as one of edit functions.

As described above in FIGS. 4 and 5, when the delete key 11 is selected, a delete key region is displayed in an overlay form on the virtual keypad region 60, and characters disposed in the character string region 21 are selectively edited.

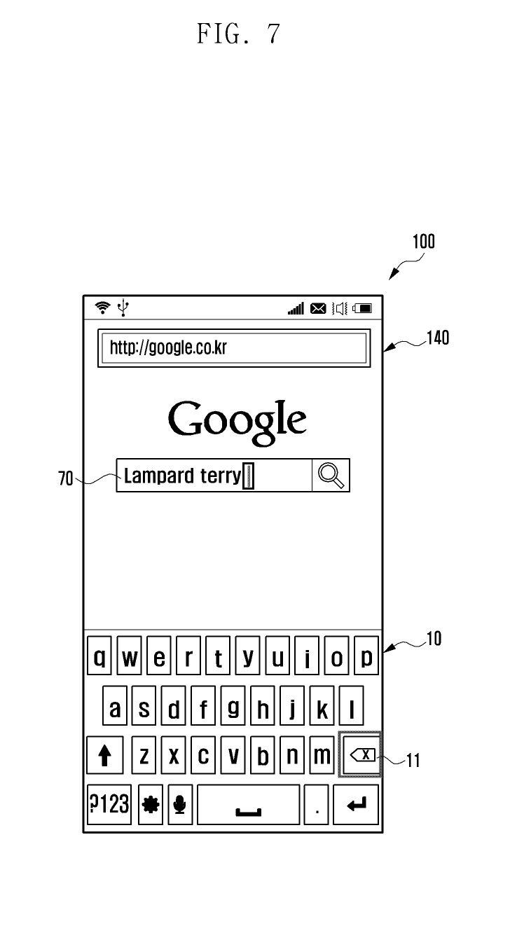

FIG. 7 illustrates an example of a screenshot displayed while providing a user function based on an operation of a virtual keypad in accordance with an embodiment of the present invention.

Referring to FIG. 7, the apparatus 100 displays a search screen. A search function may include a web-based search as well as a search for the memory unit 150. A user may create an input event for calling the virtual keypad region 10 so as to enter a search query in an input window 70. Then the device 100 may offer the virtual keypad region 10 that contains the delete key 11. Thereafter, when a touch event for selecting the delete key 11 happens, the delete key region 40 may be provided as illustrated in FIGS. 4 and 5. Therefore, a user can easily select and edit a search query in the input window 70.

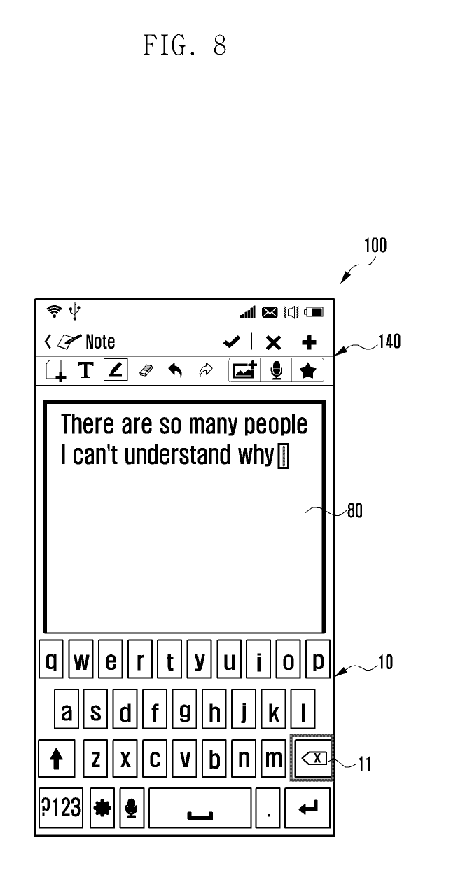

FIG. 8 illustrates an example of a screenshot displayed while providing a user function based on an operation of a virtual keypad in accordance with an embodiment of the present invention.

Referring to FIG. 8, the device 100 activates a note function. When the activation of a note function is requested, the device 100 outputs the virtual keypad region 10 on a portion of the display unit 140. The virtual keypad region 10 includes the delete key 11 to be used for selectively deleting characters displayed in a note region 80. Using the delete key 11 provided in the delete key region 40, a user can easily and exactly select desired characters from the note region 80 and then edit (e.g., delete, copy and paste, or cut and paste) the selected characters.

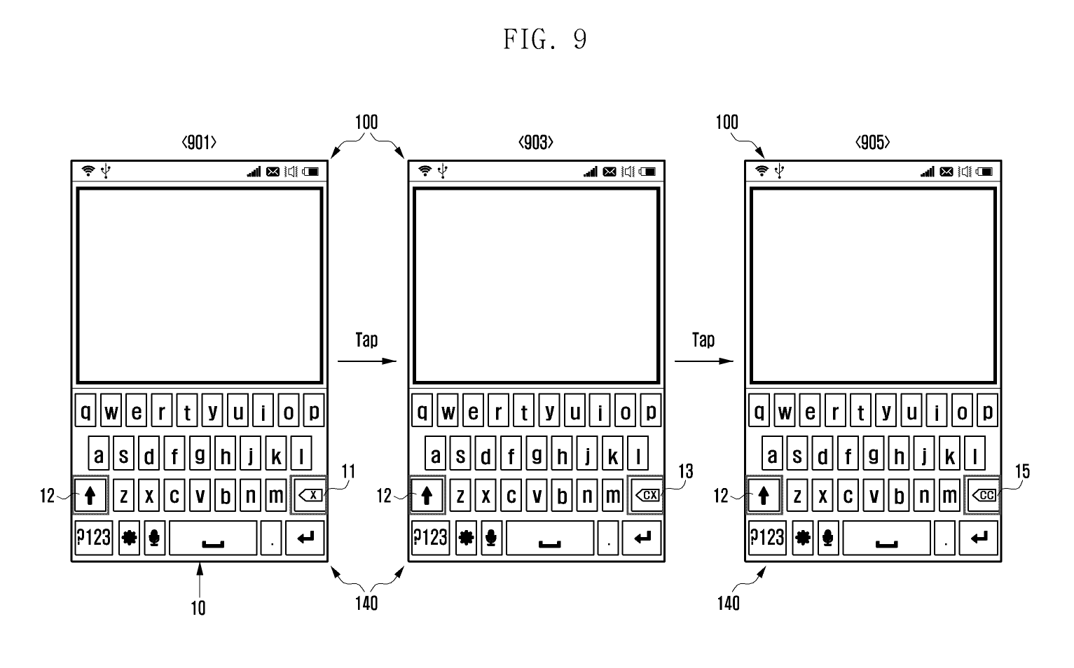

FIG. 9 illustrates an example of a screenshot displayed while changing an edit key in a virtual keypad in accordance with an embodiment of the present invention.

Referring to FIG. 9, if an edit key, i.e., the delete key 11, is selected while a shift key 12 pressed, a specific selection function assigned to the edit key may be changed in a toggle manner. For example, as illustrated in screenshot 901, the control unit 160 may change the delete key 11 to a cut key 13, as illustrated in screenshot 903. Similarly, if a selection event for selecting the cut key 13 and the shift key 12 occurs, the control unit 160 changes the cut key 13 to a copy key 15, as illustrated in screenshot 905.

After the shift key 12 is selected, the virtual keypad may maintain a press state of the shift key 12 until the shift key 12 is selected again. Therefore, a user may toggle the edit key after selecting the shift key 12 only once.

The above-described process for setting a selection function of the edit key may be performed through a separate setting screen. In this case, the control unit 160 may provide a menu item for setting a selection function and then output a suitable setting screen when such a menu item is selected. In some embodiments, when the delete key 11 is used with the shift key 12 selected, the device 100 may perform a default selection function without supporting a deletion function.

As described above, the apparatus 100 and method in the above-described embodiments provide easier, more intuitive, and more exact editing processes using a virtual keypad.

The above-described apparatus 100 may also or selectively include other elements such as a short-range communication module, a wired or wireless communication interface, an Internet communication module, a digital broadcast receiving module, etc.

Additionally, examples of the apparatus 100 include various types of mobile communication terminals such as a cellular phone, a smart phone, a tablet Personal Computer (PC), a handheld PC, a Portable Multimedia Player (PMP), a Personal Digital Assistant (PDA), a notebook, a portable game console, etc.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for providing a virtual keypad, the method comprising:
displaying a character string region and a virtual keypad region on a display, the character string region including a character string composed of a plurality of characters, and the virtual keypad region including an edit key;
receiving a selection of the edit key; and
displaying an edit key region including only the edit key and supporting a predefined selection function.

2. The method of claim 1, wherein displaying the edit key region comprises one of:
displaying the edit key region in an overlay form on the virtual keypad region; and
removing the virtual keypad region from the display unit and displaying the edit key region instead of the virtual keypad region.

3. The method of claim 1, further comprising:
selecting a portion of the character string in response to a movement of the edit key occurring in the edit key region; and
applying the predefined selection function to the selected portion of the character string.

4. The method of claim 3, wherein selecting the portion of the character string comprises:
identifying a position of a cursor in the character string region; and
selecting at least one character corresponding to a first movement direction and distance of the edit key relative to the position of the cursor.

5. The method of claim 4, wherein applying the predefined selection function comprises removing the selected at least one character from the displayed character string.

6. The method of claim 5, further comprising deleting the removed at least one character from the character string, when the selection of edit key is released.

7. The method of claim 4, further comprising releasing the selected at least one character in response to a second movement direction and a distance of the edit key, the second movement direction being opposite from the first movement direction.

8. The method of claim 7, wherein applying the predefined selection function comprises:
removing the selected at least one character from the character string according to the first movement direction and the distance of the edit key; and
restoring the removed at least one character to the character string according to the second movement direction and the distance of the edit key movement.

9. The method of claim 4, wherein selecting the at least one character comprises selecting at least one line of the character string in response to the first movement direction and the distance of the edit key, when the first movement direction is an upward direction.

10. The method of claim 3, further comprising:
buffering the character string in a first buffer, when the edit key is selected; and
buffering the selected portion of the character string in a second buffer according to the movement of the edit key in the edit key region.

11. The method of claim 10, further comprising re-initializing the first buffer and the second buffer, after the selection function is applied.

12. The method of claim 3, wherein applying the predefined selection function comprises performing one of deleting, cutting, copying, and selecting the selected portion of the character string.

13. An apparatus that provides a virtual keypad, the device comprising:
a display unit configured to display a character string region and a virtual keypad region, the character string region including a character string composed of a plurality of characters, and the virtual keypad region including an edit key; and
a control unit configured to control the display unit to display an edit key region thereon, when the edit key is selected,
wherein the edit key region includes only the edit key and supports a predefined selection function.

14. The apparatus of claim 13, wherein the display unit is further configured to display the edit key region in an overlay form on the virtual keypad region or to remove the virtual keypad region therefrom and display the edit key region instead of the virtual keypad region.

15. The apparatus of claim 13, wherein the control unit is further configured to select a portion of the character string in response to a movement of the edit key in the edit key region, and to apply the predefined selection function to the selected portion of the character string.

16. The apparatus of claim 15, wherein the control unit is further configured to identify a position of a cursor in the character string region, to select at least one character corresponding to a first movement direction and a distance of the edit key relative to the position of the cursor, to remove the selected character from the display unit, and to delete the removed character from the character string when the selection of the edit key is released.

17. The apparatus of claim 16, wherein the control unit is further configured to release the selected at least one character in response to a second movement direction and a distance of the edit key, the second movement direction being opposite the first movement direction.

18. The apparatus of claim 15, wherein the control unit is further configured to select at least one line of the character string in response to the first movement direction and the distance of the edit key, when the first movement direction is an upward direction.

19. The apparatus of claim 13, further comprising:
a first buffer configured to buffer the character string when the edit key is selected; and
a second buffer configured to buffer the selected portion of the character string according to the movement of the edit key in the edit key region,
wherein the control unit is further configured to re-initialize the first buffer and the second buffer, after the selection function is applied.

20. The apparatus of claim 13, wherein the control unit is further configured to perform one of deleting, cutting, copying, and selecting the selected portion of the character string.
